(19) United States
(12) Patent Application Publication
(10) Pub. No.: US 2024/0083780 A1
(43) Pub. Date: Mar. 14, 2024

(54) METHOD AND SYSTEM FOR TREATMENT OF SALINE-ALKALI WATER BY MULTI-MEMBRANE NANOFILTRATION AND PHOTOTHERMAL CONVERSION

(71) Applicant: ZHEJIANG UNIVERSITY, Hangzhou (CN)

(72) Inventors: Zhilin SUN, Hangzhou (CN); Yizhi SUN, Hangzhou (CN); Yunze SHEN, Hangzhou (CN)

(21) Appl. No.: 18/463,325

(22) Filed: Sep. 8, 2023

(30) Foreign Application Priority Data
Sep. 8, 2022 (CN) 202211094743.0

(51) Int. Cl. C02F 1/44; C02F 1/32

(52) U.S. Cl. CPC C02F 1/442; C02F 1/32; C02F 1/441; C02F 2103/08

(57) ABSTRACT

A method and a system for saline-alkali water treatment by multi-membrane nanofiltration and photothermal conversion are provided. The method includes the following steps: separating Na⁺ contained water from saline-alkali water by multi-membrane nanofiltration; discharging the obtained Na⁺ contained water into an evaporation zone, and evaporating in grid-shaped pools step by step by sunlight. A membrane separation method is used with nanomembrane as the core to separate monovalent ion water from high-valent ion water, thus separating Na⁺ contained water from K⁺ contained water by NF, and finally extracting fresh water from Na⁺ contained water by a NF-RO component; meanwhile, a fertilizer preparation method can be used to handle high-valent ion water, K⁺ contained water and fresh water to obtain a liquid fertilizer or a soil conditioner; a KCl drug extraction method is used to treat K⁺ contained water in step S1 to obtain a potassium-supplementing drug stock solution.

### TECHNICAL FIELD

The present application belongs to the field of hydraulic engineering and ocean engineering, and relates to a comprehensive treatment method of saline-alkali water by multi-membrane nanofiltration and photothermal conversion.

### BACKGROUND

Water shortage, soil salinization and ecological environment deterioration are the main factors that hinder the economic and social development in arid areas. Planting in arid areas of southern Xinjiang requires washing the soil with an enormous amount of fresh water, resulting in a large amount of saline-alkali water, which not only wastes water resources, but also degrades the ecological environment of the river when the saline-alkali water is discharged into Tarim River. Therefore, the resource utilization of saline-alkali water is an effective way to alleviate water short age and soil salinization, and to improve ecological environment.

Saline-alkali water contains carbide, chloride and sulfide, which is characterized by high salinity and pH value. Those elements contained in saline-alkali water significantly effects plant growth. A high concentration of NaCl will inhibit plant growth, while KCl contained in saline-alkali water is friendly to plant growth, CaCO₃ can improve the quality of soil, and high-quality salt can be extracted from salty water of a high concentration of NaCl for human beings. Therefore, the separation and utilization of different ions in saline-alkali water is very beneficial to the economic and social development in arid areas.

Seawater desalination methods are mainly divided into the membrane methods and the distillation method. The membrane methods mainly uses a reverse osmosis membrane to obtain a large amount of fresh water from seawater, and the remaining high-concentration salt water is often discharged into the sea. This method is efficient, but it has high cost and some adverse effects on the marine environment. The distillation method vaporizes seawater and then condenses it into fresh water. Depending on the heat source, it can be divided into artificial thermal and solar energy photothermal method. The former is efficient, but costly, and detrimental to the environment, while the latter is cheaper but less efficient. Traditional seawater treatment methods have their own shortcomings, so they are not suitable to be directly used for saline-alkali water treatment in arid areas.

### SUMMARY

In order to improve the existing saline-alkali water treatment technology, the present application combines the nanofiltration method with the solar energy photothermal method, and provides a method and a system for treatment of saline-alkali water by multi-membrane nanofiltration and photothermal conversion, which are suitable for saline-alkali water treatment in arid areas.

The technical solution adopted by the present application is as follows:

A method for treatment of saline-alkali water by multi-membrane nanofiltration and photothermal conversion, including the following steps:
S1. separating monovalent Na⁺ saline water from saline-alkali water by means of the multi-membrane nanofiltration; and
S2. discharging the obtained monovalent Na⁺ saline water into an evaporation zone, and evaporating step by step by using sunlight, wherein the evaporation zone consists of N grid-shaped pools arranged in sequence, the monovalent Na⁺ saline water flows through each grid-shaped pool in sequence, and an outflow at an outlet of each grid-shaped pool is controlled by the comparison between a measured salinity and a predetermined salinity, so that the salinity of last grid-shaped pool reaches saturation; an outflow velocity vₙ of the monovalent Na⁺ saline water in the n^{th} (n≤N−1) grid-shaped pool is calculated by the following formula:

$${v}_{n} = \frac{1}{k {W}_{n} Δ {h}_{n}} [ Q ( 1 - \frac{{C}_{0}}{{C}_{n}} ) - k {\sum }_{i = 1}^{n - 1} {W}_{i} Δ {h}_{i} {v}_{i} ]$$

where Q is an initial flow rate of the monovalent Na⁺ saline water; C₀ is an initial salinity of the monovalent Na⁺ saline water; Cₙ is a salinity measured at the outlet of the n^{th} grid-shaped pool, and the value of Cₙ in the formula is taken as Cₛₙ when Cₙ≤Cₛₙ, Cₛₙ is a predetermined salinity for the outlet of the n^{th} grid-shaped pool; Wₙ is an evaporation width of the n^{th} grid-shaped pool; k is an evaporation coefficient; Δhₙ is an thickness of a water layer evaporated from the n^{th} grid-shaped pool and is determined by the following relation:

−kWₙΔhₙvₙ+Q_{N}⁺−Q_{N}⁻=WₙΔĥₙvₙ

where Δĥₙ is a measured water depth change of the n^{th} grid, and Qₙ⁺ and Qₙ⁻ are boundary flow rate of the monovalent Na⁺ saline water when flowing through the n^{th} grid-shaped pool; by using the boundary condition Q_{N}⁺=Q and Q_{N}⁻=0, an outflow velocity v_{N} of the n^{th} grid-shaped pool is obtained as follows:

$${v}_{N} = \frac{1}{{W}_{N} Δ {\hat{h}}_{N}} ( \frac{Q {C}_{0}}{{C}_{N}} - {\sum }_{i = 1}^{N - 1} {W}_{i} Δ {\hat{h}}_{i} {v}_{i} ) .$$

Further, the method further includes the following step between the step S1 and the step S2:
introducing the monovalent Na⁺ saline water obtained in the step S1 into a solar heat collecting device for distillation, to increase a concentration of the monovalent Na⁺ saline water, wherein the water vapor is condensed into fresh water.

Further, the solar heat collecting device consists of a set of evaporators and a set of condensers, both connected in sequence, wherein the set of evaporators connected in sequence carries out distillation treatment by gradient heating ΔTᵢ on the monovalent Na⁺ saline water, and the set of condensers connected in sequence carries out condensation treatment on water vapor by gradient cooling ΔTₖ.

Further, in the step S1, the multimembranes of nanofiltration include a microfiltration membrane, a nanofiltration membrane and a reverse osmosis membrane, and are used for separating ions with different valences and ions with different properties at the same valence through multiple uses of the combination of the multimembrane nanofiltration; the step specifically includes:
a. using a microfiltration membrane to filter suspended substances, macromolecules and harmful substances in the saline-alkali water;
b. feeding the saline-alkali water filtered by the microfiltration membrane into a nanofiltration membrane module 1, to separate the monovalent ion saline water containing Na⁺, K⁺, Cl⁻ and a large amount of H₂O from the high-valent ion saline water containing Mg²⁺, Ca2⁺, CO₃²⁻ and SO₄²⁻ and a small amount of H₂O;
feeding the monovalent ion saline water into a nanofiltration membrane module 2 to separate Na⁺ and K⁺ of the monovalent ion saline water to form monovalent Na⁺ saline water and monovalent K⁺ saline water; and
c. feeding the monovalent Na⁺ saline water into a nanofiltration membrane-reverse osmosis membrane module, to separate NaCl molecule and H₂O molecule in the monovalent Na⁺ saline water to obtain fresh water H₂O and form monovalent Na⁺ saline water with a higher concentration.

According to the present application, fresh water in different solutions with low cost is obtained through the method of using a nanofiltration membrane, a reverse osmosis membrane followed by solar distillation.

The step b further includes treating the high-valent ion salt water, the K⁺ saline water and the fresh water in the step S1 by a fertilizer preparation method to obtain a liquid fertilizer or a soil conditioner:
obtaining a concentration ratio of high-valent ions to K⁺ in soil according to a ion concentration in collected soil, and mixing the high-valent ion saline water and monovalent K⁺ saline water obtained according to the concentration ratio of high-valent ions to K⁺ in the soil, to prepare a liquid fertilizer or a soil conditioner;
more specifically, high-valent ion saline water and monovalent K⁺ saline water are respectively discharged into different water storage tanks, several concentration detectors are installed in different areas of soil, and the soil ion concentration data collected by the concentration detectors are input into a control unit; the control unit controls the flow rate of the outlet valve of the water storage tank by analyzing the key ion concentration ratio (the concentration ratio of high-valent ions to K⁺), so that a proper amount of high-valent ion saline and monovalent K⁺ saline water are discharged into the water storage tank together;
several water spray pipes are installed at the top and bottom of the water storage tank, and the jet size of the water spray pipes is controlled to fully mix and dilute the high-valent ion saline water and monovalent K⁺ saline water in the water storage tank; several concentration detectors are installed in different areas on the wall of the water storage tank, and the collected concentration data of different areas are input into the control unit, which controls the jet flow of the water spray pipes by analyzing the concentration of key ions, so as to form a liquid fertilizer or a soil conditioner with an appropriate concentration, thereby irrigating crops and improving soil.

The preparation process includes different combinations of ion concentration ratio, outlet valve flow rate, ion concentration and jet size.

Further, the step b further comprises: preparing monovalent K⁺ saline water into a stock solution with a given KCl concentration as a potassium supplement agent.

Further, in the evaporation zone, an elevation of the bottoms of the grid-shaped pools decreases in sequence.

A system for treatment of saline-alkali water by multi-membrane nanofiltration and photothermal conversion, wherein the system is used for conducting the above method for treatment of saline-alkali water by multi-membrane nanofiltration and photothermal conversion, and includes:
a membrane separation system, configured for separating monovalent Na⁺ saline water from saline-alkali water by means of the multi-membrane nanofiltration;
an evaporation zone, consisting of N grid-shaped pools arranged in sequence, wherein the obtained monovalent Na⁺ saline water is discharged into the evaporation zone, the monovalent Na⁺ saline water flows through each grid-shaped pool in sequence, and an outflow at an outlet of each grid-shaped pool is controlled by the comparison between a measured salinity and a predetermined salinity, so that the salinity of last grid-shaped pool reaches saturation.

With the adoption of the technical solution, the present application has the following beneficial effects: fresh water resources are economically and effectively collected, liquid fertilizers and KCl medicines are extracted to obtain high-quality NaCl crystals, and CaCO₃ can be used as a soil modifier, thus realizing harmless discharge while utilizing water resources and improving saline-alkali land. The present application is green and environment-friendly, especially beneficial to improving ecological environment and human settlement environment in arid areas, and thus has a good application prospect.

### DESCRIPTION OF EMBODIMENTS

The present application will be further explained with reference to the following specific embodiments.

The present application relates to a method for treatment for saline-alkali water by multi-membrane nanofiltration and photothermal conversion, which mainly includes the following steps:
S1. separating monovalent Na⁺ saline water from saline-alkali water by a membrane separation method based on the multi-membrane nanofiltration; illustratively, the monovalent ion saline water is firstly separated from the high-valent ion saline water, then the monovalent Na⁺ saline water is separated from the monovalent K⁺ saline water by NF, and finally the fresh water in the monovalent Na⁺ saline water is extracted by a NF-RO component, which specifically includes the following sub-steps:
a. using a microfiltration membrane to filter suspended substances, macromolecules and harmful substances in the saline-alkali water: an outlet is set at the side of the water tank containing saline-alkali water 3 cm from the bottom, and a circular microfiltration membrane with a diameter of 22 cm is installed in the outlet; under the action of gravity, saline-alkali water passes through the microfiltration membrane in the outlet to filter the suspended substances, macromolecules and harmful substances in the water;
b. the saline-alkali water filtered by the microfiltration membrane flowing into a nanofiltration membrane separation system, which consists of a set of different nanofiltration membrane modules, so that monovalent ion saline water is separated from high-valence ion saline water;
a nanofiltration membrane module 1 adopts a special nanofiltration membrane capable of separating monovalent and high-valent ions, so that the monovalent ion saline water containing Na⁺, K⁺, Cl⁻ and a large amount of H₂O is separated from the high-valent ion saline water containing Mg²⁺, Ca²⁺, CO₃²⁻, SO₄²⁻ and a small amount of H₂O;
a nanofiltration membrane module 2 adopts a special nanofiltration membrane with the performance of separating Na⁺ and K⁺′ so that the Na⁺ and K⁺ in the monovalent ion saline water are separated to form monovalent Na⁺ saline water and monovalent K⁺ saline water;
c. feeding the monovalent Na⁺ saline water into a nanofiltration membrane-reverse osmosis membrane module, wherein the nanofiltration membrane-reverse osmosis membrane (NF-RO) separates NaCl molecule and H₂O molecule in the monovalent Na⁺ saline water to obtain fresh water H₂O and form monovalent Na⁺ saline water with a higher concentration.

S2. treating the high-concentration Na⁺ saline water in step S1 by using a gridding accurate salt drying method to obtain salt; specifically, the evaporation zone is divided into N rectangular grid-shaped pools with equal or unequal sizes and arranged in sequence; the above high-concentration monovalent Na⁺ saline water (with a salinity of C₀) is input into the evaporation zone, and the monovalent Na⁺ saline water flows through each grid-shaped pool in sequence; conductivity meters are installed at the outlet positions of each grid-shaped pool to collect conductivity data, which are input to the control unit for analysis to obtain salinity data; the outlet of the first N−1 grid-shaped pool controls the outflow depending on the comparison between the measured salinity and the predetermined salinity, so that the salinity of the last grid-shaped pool reaches saturation, thus realizing accurate salt drying.

According to the gridding accurate salt drying method, on the basis of salt field process calculation, control equations of gridding and outflow velocity are added, and the outflow velocity of monovalent Na⁺ saline water can be controlled according to the comparison between the salinity measured at the outlet of each grid-shaped pool and the predetermined salinity.

Further, the outflow velocity vₙ of the monovalent Na⁺ saline water in the n^{th} ((n≤N−1)) grid-shaped pool is calculated by the following formula:

Firstly, the following is obtained according to the conservation of salinity:

$${v}_{n} = \frac{1}{k {W}_{n} Δ {h}_{n}} [ Q ( 1 - \frac{{C}_{0}}{{C}_{n}} ) - k {\sum }_{i = 1}^{n - 1} {W}_{i} Δ {h}_{i} {v}_{i} ]$$

where Q is an initial flow rate of the monovalent Na⁺ saline water; C₀ is an initial salinity of the monovalent Na⁺ saline water; is a salinity measured at the outlet of the n^{th} grid-shaped pool, and the value of in the formula is taken as Cₛₙ when Cₙ≤Cₛₙ, Cₛₙ is a predetermined salinity for the outlet of the n^{th} grid-shaped pool; is an evaporation width of the n^{th} grid-shaped pool; k is an evaporation coefficient; Δhₙ is an thickness of a water layer evaporated from the n^{th} grid-shaped pool.

Δhₙ is a physical quantity that cannot be directly observed, but it has a relation.

−kWₙΔhₙvₙ+Q_{N}⁺−Q_{N}⁻=WₙΔĥₙvₙ

where Δĥₙ is a measured water depth change of the n^{th} grid and can be positive or negative. By using the boundary condition Q_{N}⁺=Q and Q_{N}⁻=0, the outflow velocity v_{N} of the N^{th} grid-shaped pool is obtained as follows:

$${v}_{N} = \frac{1}{{W}_{N} Δ {\hat{h}}_{N}} ( \frac{Q {C}_{0}}{{C}_{N}} - {\sum }_{i = 1}^{N - 1} {W}_{i} Δ {\hat{h}}_{i} {v}_{i} ) .$$

As a preferred solution, that elevation of the bottom of the grid-shaped pool is sequentially reduced by Δh, so that the evaporation zone, such as a stepped structure, can automatically flow and gradually evaporate monovalent Na⁺ saline wat in the evaporation zone under the action of gravity.

As a preferred solution, between step S1 and step S2, the Na⁺ saline water in step S1 is treated by a solar heat collection method to form high-concentration Na⁺ saline water and fresh water. Specifically, the high-concentration monovalent Na⁺ saline water in step S1 is collected in a water storage tank, and the saline water is discharged into a solar heat collecting device through a pipeline. The solar heat collecting device consists of a set of evaporators and condensers connected in sequence. Saline water passes through each evaporator in turn, and the sunlight of the evaporator is used as a heat source; the set of evaporators connected in turn carries out distillation treatment by gradient heating ΔTᵢ on the saline water, and the formed water vapor is discharged into the condenser of the heat collection device, and the condenser uses low-temperature cold water as a cold source; the set of condensers connected in turn carries out condensation treatment by gradient cooling ΔTₖ on the water vapor, so that the water vapor condenses into fresh water in the condenser, and the rest is high-concentration monovalent Na⁺ saline water.

As a preferred solution, it also includes treating the high-valent ion saline water, K⁺ saline water and fresh water in step S1 by a fertilizer preparation method to obtain a liquid fertilizer or soil conditioner. Specifically, the high-valent ion saline water and monovalent K⁺ saline water in the above step S1 are respectively discharged into different water storage tanks, several concentration detectors are installed in different areas of soil, and the collected soil ion concentration data are input into the control unit, which controls the outlet valve flow (for example 24 L/min) of the water storage tank by analyzing the key ion concentration ratio (the concentration ratio of high-valent ions to K⁺), so that a proper amount of high-valent ion saline water and monovalent K⁺ saline water are discharged into the water storage tank. At the top and bottom of the water storage tank, a set of (for example, four) water spray pipes are installed to control the jet size (for example 6 L/min) of the water spray pipes to fully mix and dilute the high-valent ion saline water and monovalent K⁺ saline water in the water storage tank. Several concentration detectors are installed in different areas on the wall of the water storage tank, and the collected concentration data of different areas are input into the control unit. The control unit controls the jet flow of the water spray pipes by analyzing the concentration of key ions, thus forming a liquid fertilizer with a certain concentration of K⁺ and a soil conditioner containing CaCO₃, so as to irrigate crops reasonably and improve soil.

As a preferred solution, it also includes treating the K⁺ saline water in step S1 with a KCl drug extraction method to obtain a potassium-supplementing drug stock solution. Specifically, the monovalent K⁺ saline water with a higher concentration mentioned in the above step S1 is collected in a water storage tank, and a stock solution with a given KCl concentration is prepared according to the relevant national standards, so as to provide raw materials for the subsequent preparation of potassium supplements.

Through the combination of the above steps, the present application completes the resource utilization of the saline-alkali water.

Corresponding to the embodiment of the method for treatment for saline-alkali water by a multi-membrane nanofiltration and photothermal conversion, the present application also provides an embodiment of a system for treatment for saline-alkali water by a multi-membrane nanofiltration and photothermal conversion.

The embodiment of the present application provides a system for treatment for saline-alkali water by multi-membrane nanofiltration and photothermal conversion, which includes:
a membrane separation system, configured for separating monovalent Na⁺ saline water from saline-alkali water by means of multi-membrane nanofiltration;
an evaporation zone, consisting of N grid-shaped pools arranged in sequence, wherein the obtained monovalent Na⁺ saline water is discharged into the evaporation zone, the monovalent Na⁺ saline water flows through each grid-shaped pool in sequence, and an outflow at an outlet of each grid-shaped pool is controlled by the comparison between the measured salinity and the predetermined salinity, so that the salinity of last grid-shaped pool reaches saturation.

As for the system embodiment, it basically corresponds to the method embodiment, so please refer to the part of the description of the method embodiment. The above-described device embodiment is only schematic, in which the units described as separate components may or may not be physically separated, and some or all of the modules may be selected according to actual needs to achieve the purpose of the solution of the present application. People of ordinary skill in the art can understand and implement it without creative labor.

The membrane separation method with nanofiltration membrane as the core of the present application can effectively purify ions of different valences of saline-alkali water to separate ions of different valences and ions of the same valence with different properties. The combination of the membrane separation method and solar heat collection method, nanofiltration membrane, reverse osmosis membrane and solar distillation can effectively obtain fresh water in different solutions with low prices. The fertilizer preparation method can effectively prepare liquid fertilizers or soil conditioners and promote plants to grow sturdily; the accurate grid salt drying method can effectively obtain salt; the KCl extraction method can effectively obtain the stock solution of potassium supplement drugs. The method has the following beneficial effects: fresh water resources are economically and effectively provided, liquid fertilizers and KCl medicines are extracted to obtain high-quality NaCl crystals, and CaCO₃ can be used as a soil modifier, thus realizing harmless discharge while utilizing water resources and improving saline-alkali land, which is green and environment-friendly and beneficial to improving ecological environment and human settlement environment in arid areas, and thus has a good application prospect.

Obviously, the above-mentioned embodiments are only examples for clear explanation, but not limitations on the implementation. For those of ordinary skill in the art, other different forms of changes or variations can be made on the basis of the above description. It is not necessary and impossible to exhaust all the embodiments here. And the obvious changes or variations derived therefrom are still within the scope of protection of the present application.

What is claimed is:

1. A method for treatment of saline-alkali water by multi-membrane nanofiltration and photothermal conversion, comprising the following steps:
S1. separating monovalent Na⁺ saline water from saline-alkali water by means of the multi-membrane nanofiltration;
S2. discharging the obtained monovalent Na⁺ saline water into an evaporation zone, and evaporating step by step by sunlight, wherein the evaporation zone consists of N grid-shaped pools arranged in sequence; the monovalent Na⁺ saline water flows through each grid-shaped pool in sequence, and an outflow at an outlet of each grid-shaped pool is controlled by the comparison between a measured salinity and a predetermined salinity, so that the salinity of last grid-shaped pool reaches saturation; an outflow velocity vₙ of the monovalent Na⁺ saline water in the n^{th} (n≤N−1) grid-shaped pool is calculated by the following formula:
$${v}_{n} = \frac{1}{k {W}_{n} Δ {h}_{n}} [ Q ( 1 - \frac{{C}_{0}}{{C}_{n}} ) - k {\sum }_{i = 1}^{n - 1} {W}_{i} Δ {h}_{i} {v}_{i} ]$$
wherein Q is an initial flow rate of the monovalent Na⁺ saline water; C₀ is an initial salinity of the monovalent Na+ saline water; Cₙ is a salinity measured at the outlet of the n^{th} grid-shaped pool, and the value of Cₙ in the formula is taken as Cₛₙ when Cₙ≤Cₛₙ, Cₛₙ is a predetermined salinity for the outlet of the n^{th} grid-shaped pool; Wₙ is an evaporation width of the n^{th} grid-shaped pool; k is an evaporation coefficient; Δhₙ is an thickness of a water layer evaporated from the n^{th} grid-shaped pool and is determined by the following relation:
−kWₙΔhₙvₙ+Q_{N}⁺−Q_{N}⁻=WₙΔĥₙvₙ
wherein Δĥₙ is a measured water depth change of the n^{th} grid, and Q_{N}⁺ and Q_{N}⁻ are boundary flow rate of the monovalent Na⁺ saline water when flowing through the n^{th} grid-shaped pool; by using the boundary condition Q_{N}⁺=Q and Q_{N}⁻=0, an outflow velocity v_{N} of the n^{th} grid-shaped pool is obtained as follows:
$${v}_{N} = \frac{1}{{W}_{N} Δ {\hat{h}}_{N}} ( \frac{Q {C}_{0}}{{C}_{N}} - {\sum }_{i = 1}^{N - 1} {W}_{i} Δ {\hat{h}}_{i} {v}_{i} )$$

2. The method according to claim 1, wherein, the method further comprises the following step between the step S1 and the step S2:
introducing the monovalent Na⁺ saline water obtained in the step S1 into a solar heat collecting device for distillation, to increase a concentration of the monovalent Na⁺ saline water, wherein the formed water vapor is condensed into fresh water.

3. The method according to claim 2, wherein, the solar heat collecting device consists of a set of evaporators and a set of condensers, both connected in sequence, wherein the set of evaporators connected in sequence carries out distillation treatment by gradient heating ΔTᵢ on the monovalent Na⁺ saline water, and the set of condensers connected in sequence carries out condensation treatment on water vapor by gradient cooling ΔTₖ.

4. The method according to claim 1, wherein, the step S1 specifically comprises:
a. using a microfiltration membrane to filter suspended substances, macromolecules and harmful substances in the saline-alkali water;
b. feeding the saline-alkali water filtered by the microfiltration membrane into a nanofiltration membrane module 1, to separate the monovalent ion saline water containing Na⁺, K⁺, Cl⁻ and a large amount of H₂O from the high-valent ion saline water containing Mg²⁺, Ca²⁺, CO₃²⁻ and SO₄²⁻ and a small amount of H₂O;
feeding the monovalent ion saline water into a nanofiltration membrane module 2 to separate Na⁺ and K⁺ in the monovalent ion saline water to form monovalent Na⁺ saline water and monovalent K⁺ saline water; and
c. feeding the monovalent Na⁺ saline water into a nanofiltration membrane-reverse osmosis membrane module, to separate NaCl molecule and H₂O molecule in the monovalent Na⁺ saline water to obtain fresh water H₂O and monovalent Na⁺ saline water with a higher concentration.

5. The method according to claim 4, wherein, the step b further comprises:
obtaining a concentration ratio of high-valent ions to K⁺ in soil according to a ion concentration in collected soil, and mixing the obtained high-valent ion saline water and monovalent K⁺ saline water according to the concentration ratio of high-valent ions to K⁺ in the soil to prepare a liquid fertilizer or a soil conditioner.

6. The method according to claim 4, wherein, the step b further comprises: preparing monovalent K⁺ saline water into a stock solution with a given KCl concentration as a potassium supplement agent.

7. The method according to claim 1, wherein, in the evaporation zone, an elevation of the bottoms of the grid-shaped pools decreases in sequence.

8. A system for treatment of saline-alkali water by multi-membrane nanofiltration and photothermal conversion, wherein, the system is used for conducting the method for treatment of saline-alkali water by multi-membrane nanofiltration and photothermal conversion according to any one of claim 1 and comprises:
a membrane separation system, configured for separating monovalent Na⁺ saline water from saline-alkali water by means of multi-membrane nanofiltration;
an evaporation zone, consisting of N grid-shaped pools arranged in sequence, wherein the obtained monovalent Na⁺ saline water is discharged into the evaporation zone, the monovalent Na⁺ saline water flows through each grid-shaped pool in sequence, and an outflow at an outlet of each grid-shaped pool is controlled by the comparison between a measured salinity and a set salinity, so that the salinity of last grid-shaped pool reaches saturation.
